(19) United States
(12) Patent Application Publication
(10) Pub. No.: US 2012/0220348 A1
(43) Pub. Date: Aug. 30, 2012

(54) TERMINAL, CONTROL METHOD THEREOF, AND PROGRAM THEREOF

(75) Inventor: Naoki TSUKUDA, Shizuoka (JP)

(73) Assignee: NEC ACCESS TECHNICA, LTD., Shizuoka (JP)

(21) Appl. No.: 13/405,971

(22) Filed: Feb. 27, 2012

(30) Foreign Application Priority Data
Feb. 28, 2011 (JP) 2011-41088

(51) Int. Cl. H04W 88/02

(52) U.S. Cl. 455/567

(57) ABSTRACT

A terminal according to the present invention is characterized in that it comprises: a vibrator which notifies the existence of an incoming call with its vibration; a measurement device which measures magnitude of the vibration applied to the terminal from the outside, when an incoming call is detected; and a controller which judges, on the basis of the measured vibration magnitude, whether or not the user can notice the vibration generated by the vibrator, and enables the vibrator to generate vibration when the judgment result is that the user can notice the vibration.

This application is based upon and claims the benefit of priority from Japanese Patent Application No. 2011-041088, filed on Feb. 28, 2011, the disclosure of which is incorporated herein in its entirety by reference.

### TECHNICAL FIELD

The present invention relates to a terminal, a control method of a terminal and a program of a terminal.

### BACKGROUND ART

In general, when a user is carrying a terminal as represented by a mobile phone in a pocket, and especially when the user is walk, it often happens that the user is unaware of a vibration alert for given by a vibrator for notifying an incoming phone call or an incoming e-mail, at the time of arrival of a phone call or an e-mail. Hereafter, an incoming phone call or an incoming e-mail is referred to as an incoming call, for simplicity.

For the purpose of solving such a problem, there are technologies in which a means for incoming call notification is changed in accordance with moving condition of a terminal. In Japanese Patent Application Laid-Open No. 2008-148155, changing of a means for incoming call notification in accordance with moving condition of a terminal is proposed. There is also a technology in which vibration magnitude of a vibrator is increased. In Japanese Patent Application Laid-Open No. 2003-018245 and Japanese Patent Application Laid-Open No. 2004-236202, increasing of vibration magnitude of a vibrator is proposed.

When employing the technology in which the means for incoming call notification is changed in accordance with moving condition of the terminal, it is necessary to keep the acceleration sensor continually in operation. As a result, the power consumption increases, and therefore, it can be said that this method for incoming call notification is undesirable for a terminal which operates on a battery.

To increase vibration magnitude of a vibrator, it is necessary to increase driving current of the vibrator. As a result, the power consumption increases, and therefore, it can be said that this technology also is undesirable for a terminal which operates on a battery.

### SUMMARY

Accordingly, the objective of the present invention is to provide a technology which can notify the user of an incoming call with lower power consumption.

In order to solve the above-mentioned problem, a terminal according to the present invention comprises: a vibrator which notifies the existence of an incoming call with its vibration; a measurement device which measures magnitude of the vibration applied to the terminal from the outside, when an incoming call is detected; and a controller which judges, on the basis of the measured vibration magnitude, whether or not the user can notice the vibration generated by the vibrator, and enables the vibrator to generate vibration when the judgment result is that the user can notice the vibration.

A control method of a terminal according to the present invention comprises: a measurement step of measuring magnitude of the vibration applied to a terminal from the outside, when an incoming call is detected; a judgment step of judging, on the basis of the measured vibration magnitude, whether or not the user can notice the vibration generated by a vibrator; and a control step of enabling the vibrator to generate vibration when the judgment result at the judgment step is that the user can notice the vibration.

A program of a terminal according to the present invention makes the terminal to function as: a vibrator which notifies the existence of an incoming call with its vibration; a measurement device which measures magnitude of the vibration applied to the terminal from the outside, when an incoming call is detected; and a controller which judges, on the basis of the measured vibration magnitude, whether or not the user can notice the vibration generated by the vibrator, and enables the vibration means to generate vibration when the judgment result is that the user can notice the vibration.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1 is a block diagram of a terminal according to the present invention;

FIGS. 2A and 2B are diagrams for illustrating timing of operation of the first exemplary embodiment of the present invention.

FIG. 3 is a diagram for illustrating operation of the first exemplary embodiment of the present invention.

FIGS. 4A and 4B are diagrams for illustrating timing of operation of the second exemplary embodiment of the present invention.

FIG. 5 is a diagram for illustrating operation of the second exemplary embodiment of the present invention.

### EXEMPLARY EMBODIMENT

In order to explain its feature, the present invention will be described concretely in the following, with reference to the drawings. The present invention is a terminal which can notify the existence of an incoming call by the use of vibration. That is, the terminal is characterized in that, on its detecting an incoming call, it measures magnitude of the vibration applied to it from the outside, and judges, on the basis of the measured vibration magnitude, whether or not the user can notice the vibration generated by a vibrator it includes, and enables the vibrator to generate vibration when the judgment result is that the user can notice the vibration. According to this feature, an incoming call can be notified to the user with lower power consumption.

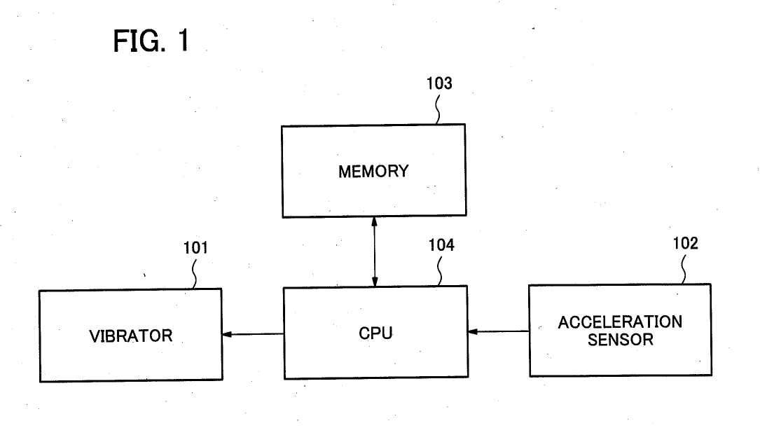

Next, preferred exemplary embodiments of the present invention will be described in detail with reference to the drawings. First, the first exemplary embodiment of the present invention will be described in detail with reference to the drawings. FIG. 1 is a block diagram of a terminal according to the present invention.

The terminal according to the present exemplary embodiment is a terminal as represented by a mobile terminal which the user can carry holding it in a pocket and the like. As shown in FIG. 1, the terminal includes a vibrator 101, an acceleration sensor 102, a memory 103 and a central processing unit 104. The central processing unit 104 will be referred to as CPU 104 hereafter.

The vibrator 101 has a vibration function, and generates vibration when there is arrival of a phone call or an e-mail, so as to notify the user of the incoming call.

When an incoming call is detected, the acceleration sensor 102 measures magnitude of the vibration applied to the terminal from the outside.

The memory 103 stores a threshold value to be used for judging whether or not the vibration function of the vibrator 101 should be turned on.

When an incoming call is detected, the CPU 104 notifies the acceleration sensor 102 to start the measurement. Comparing the vibration magnitude measured by the acceleration sensor 102 with the threshold value stored in the memory 103, the CPU 104 judges whether or not the user can notice the vibration to be generated by the vibrator 101. That is, the CPU 104 determines whether or not to turn on the vibration function of the vibrator 101, comparing the vibration magnitude measured by the acceleration sensor 102 with the threshold value stored in the memory 103. On determining to turn on the vibration function, the CPU 104 notifies the vibrator 101 to start generating vibration. Further, the CPU 104 confirms whether or not the user has performed any action on the terminal such as answering the phone call or viewing the e-mail becoming aware of the incoming call. If the user has not performed any action on the terminal, after the vibrator's generating vibration for a specific time period or a specific number of times, the CPU 104 notifies the acceleration sensor 102 to start the measurement. The CPU 104 makes the notification of starting the measurement at the time when the vibrator 101 is not generating vibration, so that the vibration generated by the vibrator 101 does not affect the vibration magnitude measured by the acceleration sensor 102.

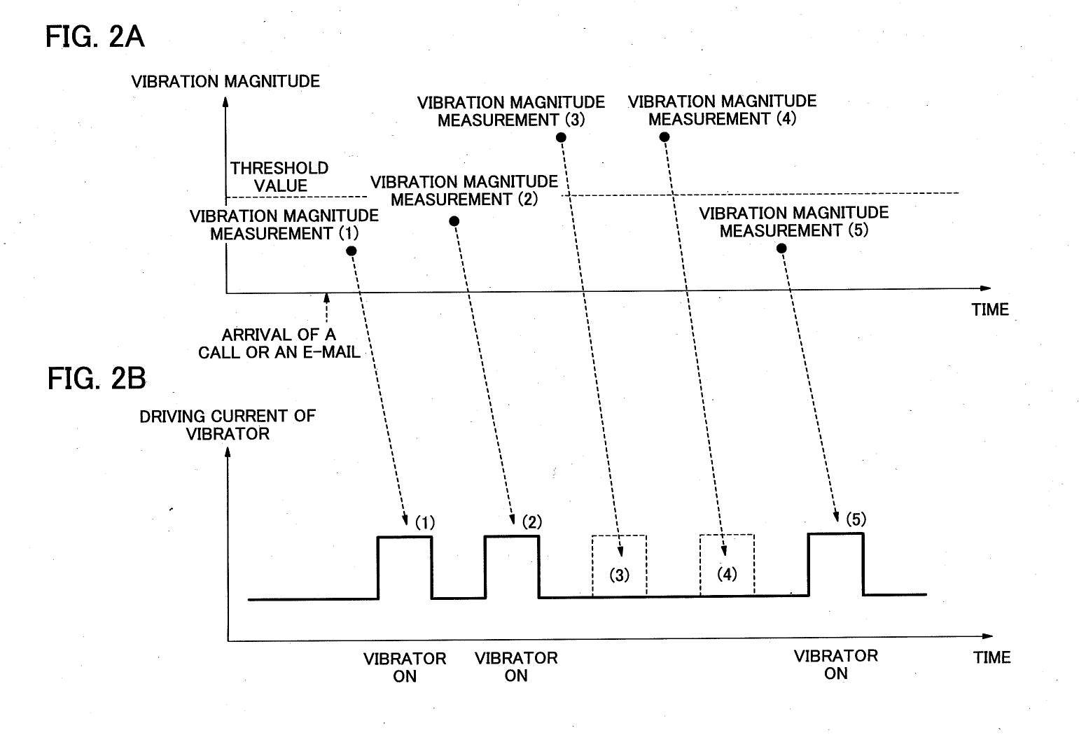

Timing charts of the operation of the first exemplary embodiment are shown in FIGS. 2A and 2B. FIG. 2A shows a relation between measured vibration magnitude and time of measurement, and FIG. 2B shows ON/OFF operations of the vibration function in accordance with the results of the vibration magnitude measurements. In FIG. 2A, at vibration magnitude measurements (1), (2) and (5), the measured vibration magnitudes are all smaller than the threshold value. In these cases, since the user is expected to notice the vibration generated by the vibrator, the vibration function is turned on. In FIG. 2A, at vibration magnitude measurements (3) and (4), the measured vibration magnitudes are both larger than the threshold value. In these cases, since the user is expected to be unable to notice the vibration generated by the vibrator, the vibration function is not turned on.

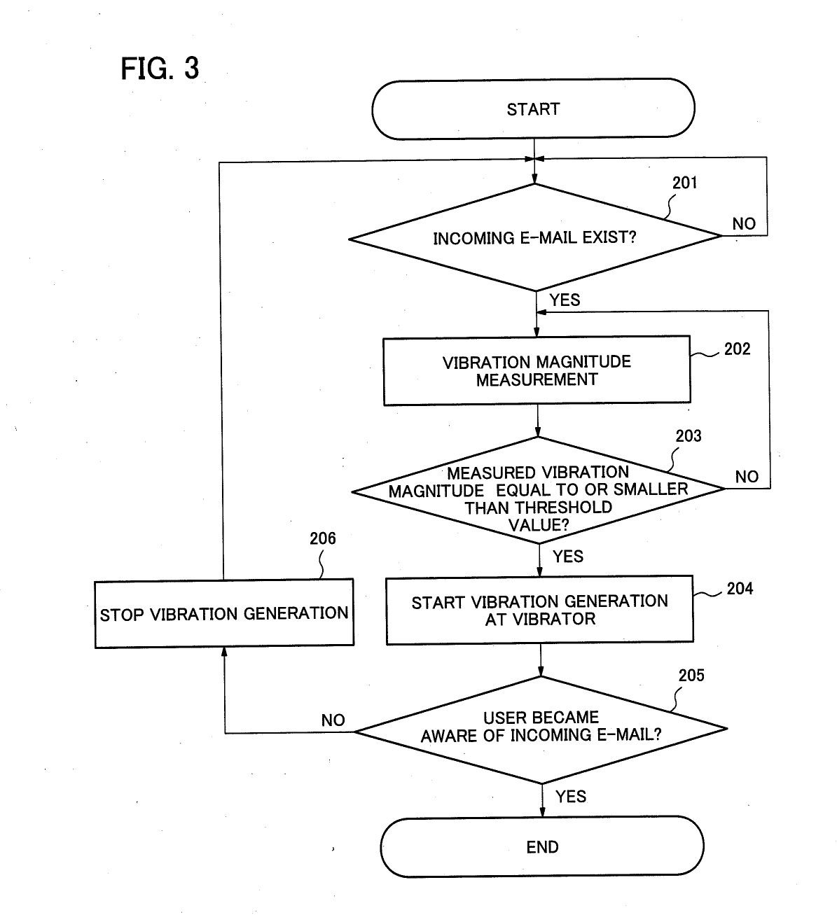

Next, operation of the terminal according to the present exemplary embodiment will be described. FIG. 3 is a flow chart for illustrating operation of the present exemplary embodiment.

At step 201, the CPU 104 judges the presence or absence of arrival of a phone call, an e-mail or the like. At this step, if the CPU 104 detects arrival of an e-mail, for example, it orders the acceleration sensor 102 to start the measurement.

At step 202, the acceleration sensor 102 measures magnitude of the vibration applied to the terminal from the outside. In this state, the vibrator 101 is not generating vibration, and thus the vibration magnitude is measured in the state where the vibrator 101 is not generating vibration.

Next, at step 203, the CPU 104 judges whether or not the measured vibration magnitude is equal to or smaller than the threshold value. If the measured vibration magnitude is not equal to or smaller than the threshold value, the CPU 104 returns to step 202. Alternatively, the CPU 104 may perform incoming call notification by voice before returning to step 202.

On the other hand, if the measured vibration magnitude is equal to or smaller than the threshold value, the CPU 104 notifies the vibrator 101 to start generating vibration (YES at step 203). At step 204, the vibrator 101 starts generating vibration.

After the generation of vibration is started by the vibrator 101, at step 205, the CPU 104 confirms whether or not the user has performed any action on the terminal becoming aware of the incoming call. If the user has performed any action (YES at step 205), the CPU 104 judges that the incoming call notification has been recognized by the user, and accordingly finishes the incoming call notification.

On the other hand, if the user has not performed any action on the terminal being unaware of the incoming call, even having the vibration given by the vibrator 101 (NO at step 205), the vibration is generated by the vibrator 101 for a specific period of time or a specific number of times, and then is stopped at step 206, and the CPU 104 subsequently returns to step 201.

According to this exemplary embodiment of the present invention, when the notification by the vibrator is judged to be effective because the user is nearly stationary, the CPU 104 turns on the vibrator 101 to perform the incoming call notification by the use of the vibration function, but when the notification by the vibrator 101 is considered to be ineffective, the CPU 104 does not turn on the vibrator 101. As a result, it is possible to notify the user of an incoming call with lower power consumption. Accordingly, power consumption of the terminal can be suppressed, and wasteful use of the battery of the terminal is thus avoided.

Next, the second exemplary embodiment of the present invention will be described in detail with reference to the drawings. Here, with respect to the configurations similar to that in the above-described first exemplary embodiment, the same numerical references are given to them without giving detailed explanations.

Similarly to the first exemplary embodiment, a terminal according to the present exemplary embodiment comprises a vibrator 101, an acceleration sensor 102, a memory 103 and a CPU 104.

The CPU 104 compares a vibration magnitude measured by the acceleration sensor 102 with a threshold value stored in the memory 103. On judging that the vibration magnitudes measured at continuous N times measurements are all equal to or smaller than the threshold value, the CPU 104 notifies the vibrator 101 to start generating vibration. Here, N is assumed to be an optional number selected from the natural numbers equal to or larger then two.

The memory 103 stores the optional number N.

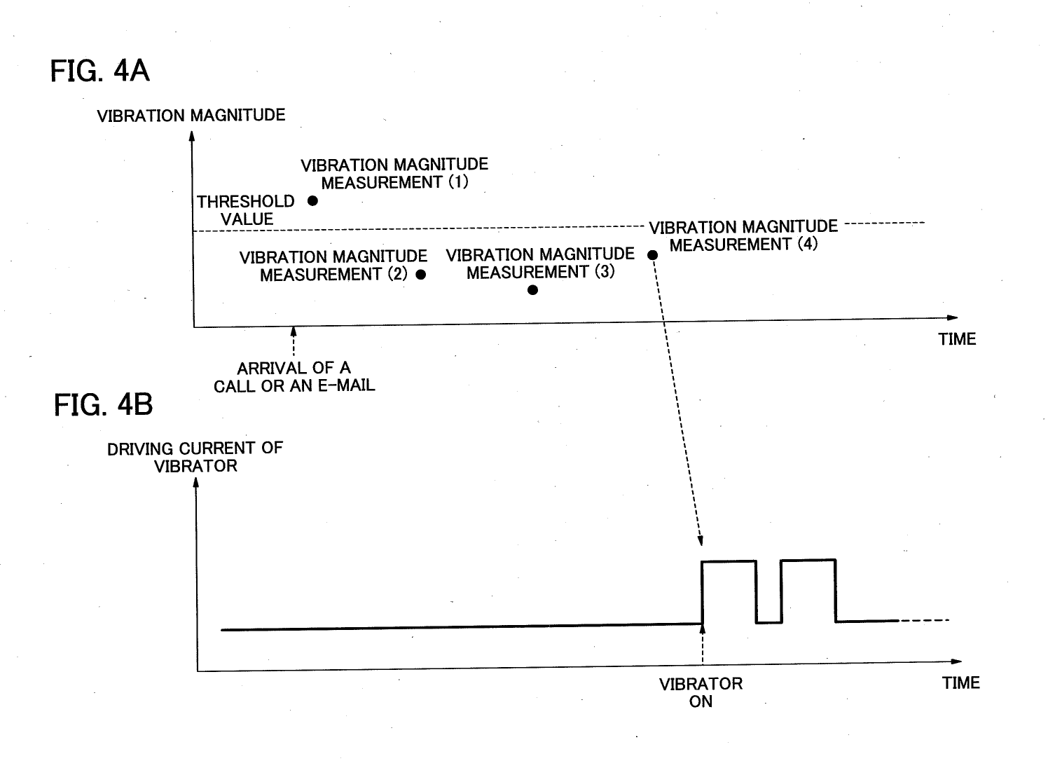

Timing charts of operation of the second exemplary embodiment are shown in FIGS. 4A and 4B. FIG. 4A shows a relation between measured vibration magnitude and time of measurement, and FIG. 4B shows ON/OFF operations of the vibration function in accordance with the results of the vibration magnitude measurements. In FIG. 4A, vibration magnitudes measured at vibration magnitude measurements (2), (3) and (4), that is, the vibration magnitudes at three continuous measurement points of time, are all smaller than the threshold value. In this case, since the user is expected to notice the vibration generated by the vibrator 101, the vibration function is turned on.

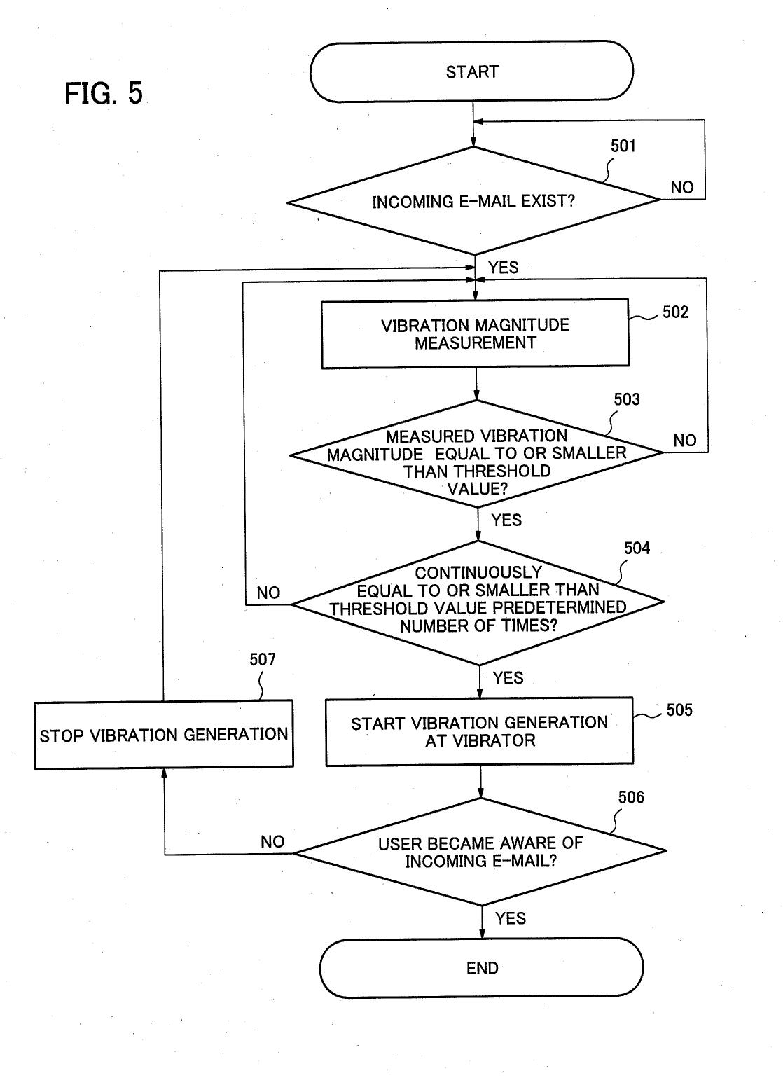

Next, operation of the terminal according to the present exemplary embodiment will be described. A flow chart for illustrating operation of the present exemplary embodiment is shown in FIG. 5.

At step 501, the CPU 104 judges the presence or absence of arrival of a phone call, an e-mail or the like. At this step, if the CPU 104 detects arrival of an e-mail, for example, it orders the acceleration sensor 102 to start the measurement.

At step 502, the acceleration sensor 102 measures magnitude of the vibration applied to the terminal from the outside. In this state, the vibrator 101 is not generating vibration, and thus the vibration magnitude is measured in the state where the vibrator 101 is not generating vibration.

Next, at step 503, the CPU 104 judges whether or not the measured vibration magnitude is equal to or smaller than the threshold value. If the measured vibration magnitude is not equal to or smaller than the threshold value, the CPU 104 returns to step 502 without performing any operation. Alternatively, the CPU 104 may perform incoming call notification by voice before returning to step 502

On the other hand, if the measured vibration magnitude is equal to or smaller than the threshold value, the CPU 104 confirms whether or not the results equal to or smaller than the threshold value have been measured a predetermined number of times continuously (step 504). If the number of times the measurement results have been continuously equal to or smaller than the threshold value is smaller than the predetermined number of times, the CPU 104 returns to step 502 (NO at step 504).

On the other hand, if the number of times the measurement results have continuously been equal to or smaller than the threshold value is equal to or larger than the predetermined number of times, the CPU 104 notifies the vibrator 101 to start generating vibration (YES at step 504). At step 505, the vibrator 101 starts generating vibration.

After the generation of vibration is started by the vibrator 101, at step 506, the CPU 104 confirms whether or not the user has performed any action on the terminal becoming aware of the incoming call. If the user has performed any action (YES at step 506), the CPU 104 judges that the incoming call notification has been recognized by the user, and accordingly finishes the incoming call notification.

On the other hand, if the user has not performed any action on the terminal being unaware of the incoming call, even having the vibration given by the vibrator 101 (NO at step 506), the vibration is generated by the vibrator 101 for a specific period of time or a specific number of times, and then is stopped at step 507, and the CPU 104 subsequently returns to step 502.

According to this exemplary embodiment of the present invention, similarly to the first exemplary embodiment, when the notification by the vibrator is judged to be effective because the user is nearly stationary, the CPU 104 turns on the vibrator 101 to perform the incoming call notification by the use of the vibration function, but when the notification by the vibrator is considered to be ineffective, the CPU 104 does not turn on the vibrator 101. As a result, it is possible to notify the user of an incoming call with lower power consumption. Accordingly, power consumption of the terminal can be suppressed, and wasteful use of the battery of the terminal is thus avoided.

According to the present exemplary embodiment, judgment is made on whether or not the vibration magnitudes measured at continuous multiple points of time are all equal to or smaller than a threshold value, and accordingly, accuracy of detection of whether or not a terminal is stationary is increased. Since a judgment that a terminal is nearly stationary is made after such steps, it is possible to notify the user of an incoming call by the use of a vibrator with higher certainty.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

A part or whole of the above-described exemplary embodiments may be described also as the following supplementary notes, but it is not limited to the following.

(Supplementary note 1) A terminal comprising:

a vibrator which notifies the existence of an incoming call with its vibration;

a measurement device which measures magnitude of the vibration applied to the terminal from the outside, when an incoming call is detected; and

a controller which judges, on the basis of the measured vibration magnitude, whether or not the user can notice the vibration generated by the vibrator, and enables the vibrator to generate vibration when the judgment result is that the user can notice the vibration.

(Supplementary note 2) The terminal according to supplementary note 1, wherein said judgment on whether or not the user can notice said vibration generated by said vibrator is made based on whether or not said measured vibration magnitude is equal to or smaller than a threshold value.

(Supplementary note 3) The terminal described in supplementary notes 1 or supplementary note 2, wherein the measurement device continues the vibration measurement periodically until the user becomes aware of the incoming call.

(Supplementary note 4) The terminal described in any one of supplementary notes 1 to 3, wherein the controller makes the vibrator stop generating vibration, if, as a result of the above-mentioned judgment, the user is not expected to notice the vibration.

(Supplementary note 5) The terminal described in any one of supplementary notes 1 to 4, wherein said controller makes said vibrator vibrate, when said controller judges that the user can notice the vibration several times consecutively.

(Supplementary note 6) The terminal described in any one of supplementary notes 1 to 5, wherein the measurement device performs the vibration measurement during a time when the vibrator is not generating vibration.

(Supplementary note 7) A control method of a terminal, the control method comprising:

a measurement step, where magnitude of the vibration applied to the terminal from the outside is measured, when an incoming call is detected;

a judgment step, where, on the basis of the measured vibration magnitude, judgment is made on whether or not the user can notice the vibration generated by the vibrator; and

a control step, where, when the judgment made at the judgment step is that the user can notice the vibration, the vibrator is enabled to generate vibration.

(Supplementary note 8) The control method described in supplementary note 7, wherein, at the measurement step, the vibration measurement is continued periodically until the user becomes aware of the incoming call.

(Supplementary note 9) The control method described in supplementary note 7 or supplementary note 8, wherein, at the control step, the vibration generated by the vibrator is halted, if, as a result of the above-mentioned judgment, the user is not expected to notice the vibration.

(Supplementary note 10) The control method described in any one of supplementary notes 7 to 9, wherein, at the control step, said controller makes said vibrator vibrate, when said controller judges that the user can notice the vibration several times consecutively.

(Supplementary note 11) The control method described in any one of supplementary notes 7 to 10, wherein, at the measurement step, the vibration measurement is performed during a time when the vibrator is not generating vibration.

(Supplementary note 12) A program of a terminal, the program makes the terminal to function as:

a vibrator which notifies the existence of an incoming call with its vibration;

a measurement device which measures magnitude of the vibration applied to the terminal from the outside, when an incoming call is detected; and

a controller which judges, on the basis of the measured vibration magnitude, whether or not the user can notice the vibration generated by the vibrator, and enables the vibrator to generate vibration when the judgment result is that the user can notice the vibration.

(Supplementary note 13) The program described in supplementary note 12, wherein the measurement device continues the vibration measurement periodically until the user becomes aware of the incoming call.

(Supplementary note 14) The program described in supplementary note 12 or supplementary note 13, wherein the controller makes the vibrator stop generating vibration, if, as a result of the above-mentioned judgment, the user is not expected to notice the vibration.

(Supplementary note 15) The program described in any one of supplementary notes 12 to 14, wherein said controller makes said vibrator vibrate, when said controller judges that the user can notice the vibration several times consecutively.

(Supplementary note 16) The program described in any one of supplementary notes 12 to 15, wherein the controller performs the vibration measurement during a time when the vibrator is not generating vibration.

1. A terminal comprising:
a vibrator which notifies the existence of an incoming call with its vibration;
a measurement device which measures magnitude of the vibration applied to the terminal from the outside, when an incoming call is detected; and
a controller which judges, on the basis of said measured vibration magnitude, whether or not the user can notice said vibration generated by said vibrator, and enables said vibrator to generate vibration when the judgment result is that the user can notice the vibration.

2. The terminal according to claim 1, wherein said judgment on whether or not the user can notice said vibration generated by said vibrator is made based on whether or not said measured vibration magnitude is equal to or smaller than a threshold value.

3. The terminal according to claim 2, wherein said measurement device continues the vibration measurement periodically until the user becomes aware of said incoming call.

4. The terminal according to claim 2 wherein said controller makes said vibrator stop generating vibration, if, as a result of said judgment, the user is not expected to notice the vibration.

5. The terminal according to claim 2 wherein said controller makes said vibrator vibrate, when said controller judges that the user can notice the vibration several times consecutively.

6. The terminal according to claim 2, wherein said measurement device performs the vibration measurement during a time when said vibrator is not generating vibration.

7. The terminal according to claim 3, wherein said controller makes said vibrator stop generating vibration, if, as a result of said judgment, the user is not expected to notice the vibration.

8. The terminal according to claim 3 wherein said controller makes said vibrator vibrate, when said controller judges that the user can notice the vibration several times consecutively.

9. The terminal according to claim 4 wherein said controller makes said vibrator vibrate, when said controller judges that the user can notice the vibration several times consecutively.

10. A control method of a terminal, the control method comprising:
a measurement step, where magnitude of the vibration applied to the terminal from the outside is measured, when an incoming call is detected;
a judgment step, where, on the basis of said measured vibration magnitude, judgment is made on whether or not the user can notice said vibration; and
a control step, where, when the judgment made at said judgment step is that the user can notice the vibration, a vibrator is enabled to generate vibration.

11. The control method of a terminal according to claim 10, wherein said judgment on whether or not the user can notice said vibration generated by said vibrator is made based on whether or not said measured vibration magnitude is equal to or smaller than a threshold value.

12. The control method according to claim 11, wherein, at said measurement step, the vibration measurement is continued periodically until the user becomes aware of said incoming call.

13. The control method according to claim 11, wherein, at said control step, the vibration generated by said vibrator is halted, if, as a result of said judgment, the user is not expected to notice the vibration.

14. The control method according to claim 11, wherein, at said control step, said controller makes said vibrator vibrate, when said controller judges that the user can notice the vibration several times consecutively.

15. The control method according to claim 11, wherein, at said measurement step, the vibration measurement is performed during a time when said vibrator is not generating vibration.

16. The control method according to claim 12, wherein, at said control step, the vibration generated by said vibrator is halted, if, as a result of said judgment, the user is not expected to notice the vibration.

17. The control method according to claim 12, wherein, at said control step, said controller makes said vibrator vibrate, when said controller judges that the user can notice the vibration several times consecutively.

18. The control method according to claim 13, wherein, at said control step, wherein said controller makes said vibrator vibrate, when said controller judges that the user can notice the vibration several times consecutively.

19. A program of a terminal, the program making the terminal function as:
a vibrator which notifies the existence of an incoming call with its vibration;
a measurement device which measures magnitude of the vibration applied to the terminal from the outside, when an incoming call is detected; and
a controller which judges, on the basis of said measured vibration magnitude, whether or not the user can notice said vibration generated by said vibrator, and enables said vibrator to generate vibration when the judgment result is that the user can notice the vibration.
